(19) United States
(12) Patent Application Publication
(10) Pub. No.: US 2009/0300232 A1
(43) Pub. Date: Dec. 3, 2009

(54) DATA TRANSMISSION METHOD BETWEEN A HOST DEVICE AND A DISPLAY APPARATUS

(75) Inventor: Chun-Yu CHEN, Tainan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HIMAX TECHNOLOGIES LIMITED, Tainan County (TW)

(21) Appl. No.: 12/128,679

(22) Filed: May 29, 2008

(51) Int. Cl. G06F 13/00

(52) U.S. Cl. 710/33

(57) ABSTRACT

A display apparatus is provided. The display apparatus is coupled to a host device and comprises a control module and a microprocessor. The control module sequentially receives data packets from the host device, acquires data content from each of the received data packets, collects each of the data contents, and, when data transfer has been completed, sends a control signal. The microprocessor is coupled to the control module and, in response to the control signal, acquires the collected data contents from the control module, decodes the acquired data contents to generate a decoded result and performs at least one operation corresponding to the decoded result to generate a reply information to the host device.

### BACKGROUND OF THE INVENTION

1. Field of the Invention

The invention relates to a system and method for data transmission, and more particularly to a data transmission method for performing a Display Data Channel/command interface (DDC/CI) transmission between a host device and a display apparatus.

2. Description of the Related Art

Current modern display apparatuses, (e.g. a CRT, LCD, PDP monitor, etc.), allow users to adjust or acquire settings data of a display apparatus (such as brightness and colour balance) through a Display Data Channel (DDC) or a DDC/CI (command interface) transmission instead of using the on-screen function buttons on the display apparatus. The DDC, which was a standard created by the Video Electronics Standards Association (VESA), is a digital connection between the display apparatus and a host device (e.g. graphics adapter on a personal computer (PC)) that allows the display to communicate its specifications to the adapter. The DDC/CI is an upgrade to the DDC specified by the VESA in August 1998, allowing a computer with a suitably designed graphics adapter to adjust monitor parameters or settings data such as brightness and colour balance, or to initiate degaussing.

The VESA's DDC/CI standard defines communication protocol and implementation of applications for PC (host device) and monitor bi-directional communications. A communication line is typically provided in a DVI or D-SBU port, which is used as the video port to support a display data channel (DDC) so that extended display identification data (EDID) information may be transmitted from the display apparatus to the computer. Currently, implementations are based on Inter-Integrated Circuit (I2C) data transfer and a software decoder, such as implementations utilizing a microprocessor or an additional chip capable of receiving I2C data packet. The implementations, however, process a request from the host device per byte or per bit, reducing the performance of DDC/CI data transfer between the host device and the display apparatus.

### BRIEF SUMMARY OF THE INVENTION

A display apparatus is provided. The display apparatus is coupled to a host device and comprises a control module and a microprocessor. The control module sequentially receives data packets from the host device, acquires data content from each of the received data packets, collects each of the data contents, and, when data transfer has been completed, sends a control signal. The microprocessor is coupled to the control module and, in response to the control signal, acquires the collected data contents from the control module, decodes the acquired data contents to generate a decoded result and performs at least one operation corresponding to the decoded result to generate a reply information to the host device.

A data transmission method for transmission between a host device and a display apparatus is further provided. The display apparatus comprises a microprocessor and a control module. The method comprises the following steps. Data packets from the host device are sequentially received by the control module. Next, data content from each of the received data packets are acquired. Thereafter, each of the data contents is collected and a control signal is sent when data transfer has been completed. The collected data contents are acquired from the control module by the microprocessor in response to the control signal. Next, the acquired data contents are decoded to generate a decoded result. Finally, at least one operation corresponding to the decoded result is performed to generate a reply information to respond to the host device.

A communication system is further provided. The communication system comprises a host device and a display apparatus. The host device sends a request with a plurality of data packets. The display apparatus is coupled to the host device and comprises a control module and a microprocessor. The control module sequentially receives data packets from the host device, acquires data content from each of the received data packets, collects each of the data contents, and, when data transfer has been completed, sends a control signal. The microprocessor is coupled to the control module and, in response to the control signal, acquires the collected data contents from the control module, decodes the acquired data contents to generate a decoded result and performs at least one operation corresponding to the decoded result to generate a reply information to the host device.

A data transmission method for performing a Display data channel/command interface (DDC/CI) transmission between a host device and a display apparatus is further provided. The display apparatus comprises a microprocessor and a control module. First, all of data packets corresponding to a request from the host device are received by the control module. Next, the microprocessor is informed to acquire the received data packets when data transfer has been completed. The acquired data packets are then decoded by the microprocessor to generate a decoded result, wherein each of the acquired data packets is stored together during the data transfer.

### BRIEF DESCRIPTION OF THE DRAWINGS

The invention can be more fully understood by reading the subsequent detailed description and examples with references made to the accompanying drawings, wherein:

FIG. 1 shows an embodiment of a communication system;

FIG. 2 shows an embodiment of the data format of a data packet;

FIG. 3 is a flowchart of a data transmission method for transmission from a host device to a display apparatus according to the invention;

FIG. 4 is a flowchart of a data transmission method for transmission from a display apparatus to a host device according to the invention; and

FIG. 5 shows another embodiment, of a communication system.

### DETAILED DESCRIPTION OF THE INVENTION

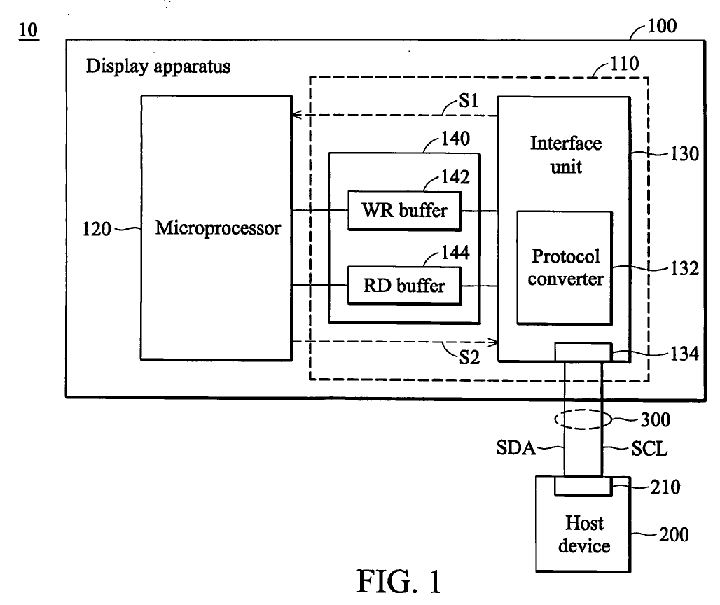

FIG. 1 shows an embodiment of a communication system 10. As shown in FIG. 1, the communication system 10 comprises a display apparatus 100 and a host device 200 in which the display apparatus 100 is connected to the host device 200 through a communication line 300. The communication line 300 comprises a serial clock (SCL) line to send and receive a clock signal, and a serial data (SDA) line to send and receive data. The display apparatus 100 and the host device 200 may perform I2C communication with each other through the communication line 300. The host device 200, such as a personal computer (PC), sends a request to the display apparatus 100 to obtain data from the display apparatus 100 or adjust settings data of the display apparatus 100, and waits for a response therefrom via the communication line 300. The request usually follows a specific communication standard and contains a plurality of data packets. Each data packet may contain a specific data format, e.g. a portion of header data and a portion of data content (i.e. a corresponding command data).

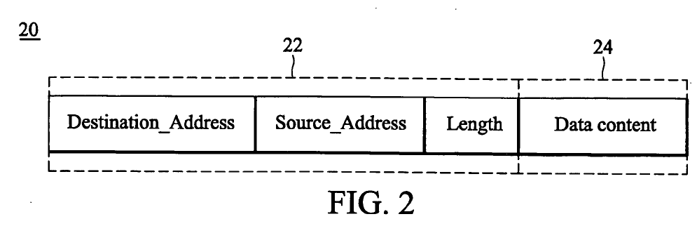

FIG. 2 shows an embodiment of the data format of a data packet 20. As shown in FIG. 2, the data packet 20 contains a portion of header data 22 and a portion of data content 24 that represents a corresponding command data. The header data 22 may comprise a field Destination_Address for indicating where the data packet is to be sent to, a field Source_Address for indicating where the data packet was received from, and a field Length for indicating lengths of the data content contained. The data packet 20 may be compatible with, in this embodiment, a DDC/CI standard. Thus, the request follows a DDC/CI standard and thus data content is a DDC/CI command.

The display apparatus 100 may further comprise a control module 110 and a microprocessor 120 which is coupled to control module 110. When a request with a plurality of data packets is issued by the host device 200, the control module 110 receives the request, processes data packets from the received request to collect data contents during the data transfer and sends a control signal to inform the microprocessor 120 when the data transfer has been completed. The control signal may be, for example, an interrupt signal S1 generated by the control module 110, but is not limited thereto. Upon receiving the control signal (e.g. an interrupt signal S1), the microprocessor 120 acquires the collected data contents from the control module 110, decodes the acquired data contents to generate a decoded result and performs at least one operation corresponding to the decoded result to generate a reply information to the host device 200. For example, if the request is a command relating to obtaining settings data of the display apparatus 100, the microprocessor 120 may decode the request to recognize the meaning of the command and generate a corresponding reply information with the required settings data to the control module 110 to respond to the host device 200. Similarly, after the reply information is generated, the microprocessor 120 may send a notification signal (e.g. an interrupt signal S2) to inform the control module 110.

The control module 110 further comprises an interface unit 130 and a buffering unit 140. The interface unit 130 may further comprise a protocol converter 132 and a connection interface 134. The connection interface 134 of the interface unit 130 is coupled to a connection interface 210 of the host device 200 to perform an I2C communication therebetween via the communication line 300. The connection interface 210 and the connection interface 134 may be any connectable serial interfaces such as an I2C interface, as the same as the communication line 300. In particular, in this embodiment, the host device 200 is capable of performing DDC/CI or I2C communication with the display apparatus 100 via the communication line 300. The control module 110 is capable of receiving the data packets from the host device 200 via the connection interface 134 and the protocol converter 132 is capable of acquiring the data content from each of the received data packets. As described previously, a data packet may comprise a portion of header data and a portion of data content (i.e. a corresponding command data). In this case, the protocol converter 132 may decode a received data packet and acquire only the necessary data content (e.g. the data content representing a command) from the received data packet. The protocol converter 132 may also decode a reply information generated by the microprocessor 120 and generate data packets with corresponding header data based on the decoded result so as to pass the data packets to the host device 200 using an I2C communication via the communication line 300.

The buffering unit 140 is coupled between the interface unit 130 and the microprocessor 120 for collecting each of the data contents acquired by the interface unit 130 or storing the reply information generated by the microprocessor 120. In this embodiment, the buffering unit 140 may comprise a WR buffer 142 and a RD buffer 144 in which the WR buffer 142 is used for the interface unit 130 to collect each of the data contents acquired, while the RD buffer 144 is used for the microprocessor 120 to store the reply information generated. Typically, the buffer is defined as being large enough to store all the data packets. In some cases, the buffer capacity may be smaller than that of the received data packets and thus the buffer may be full. A buffer is identified as being full when no available space is available in the buffer. When the WR buffer 142 or RD buffer 144 is full, it may issue a signal (e.g. an interrupt signal) to notify the interface unit 130 or the microprocessor 120 to stop filling of data. Upon receiving the signal issued by the WR buffer 142 or RD buffer 144, the transmitting end (i.e. the interface unit 130 or the microprocessor 120) may pause or interrupt the data transfer and send the control signal or the notification signal, respectively, to direct the corresponding receiving end (i.e. the microprocessor 120 or the interface unit 130) to read out the buffered data content and then resume the paused or interrupted data transfer once it is emptied so as to complete the data transfer.

It is to be noted that the buffering unit 140 may comprise any storable elements capable of temporarily storing the received data packet, such as a first-in-first-out (FIFO) buffer, and the length (i.e. buffer capacity) and number of buffers used in the buffering unit 140 can be determined in advance based on system or user requirements. For example, in some embodiment, the WR and RD buffers may be combined together into one single buffer so that the data contents acquired by the interface unit 130 and the reply information are both stored or collected at the same buffer for saving hardware costs.

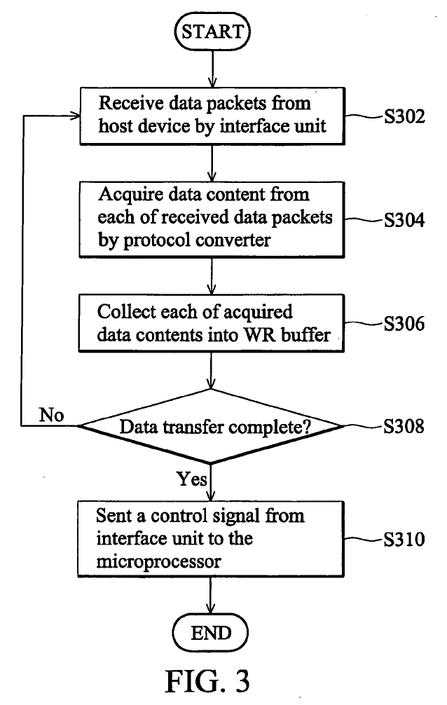

FIG. 3 is a flowchart of a data transmission method for transmission from a host device to a display apparatus according to the invention. Referring to FIGS. 1, 2 and 3, assuming that the host device issues a request with a plurality of data packets 20 to the display apparatus 100, in step S302, data packets from the host device is received one by one by the interface unit 130 via the connection interface 134. As described previously, each data packet may comprise a portion of header data and a potion of data content. In step S304, data content is acquired from each of the received data packets by the protocol converter 132. The acquired data content comprises necessary data for the microprocessor to decode it. Next, in step S306, each of the acquired data contents is collected or stored into the WR buffer 142. In step S308, it is determined whether data transfer has been completed. If the data transfer has not been completed (No in step S308), the process repeats steps S302-S306 for acquiring subsequent data contents. Thus, all of the data contents belonging to the request will be collected into the WR buffer 142 during data transfer. Contrarily, if the data transfer has been completed (Yes in step S308), a control signal (e.g. an interrupt signal S1) is sent from the interface unit 130 to the microprocessor 120 (step S310).

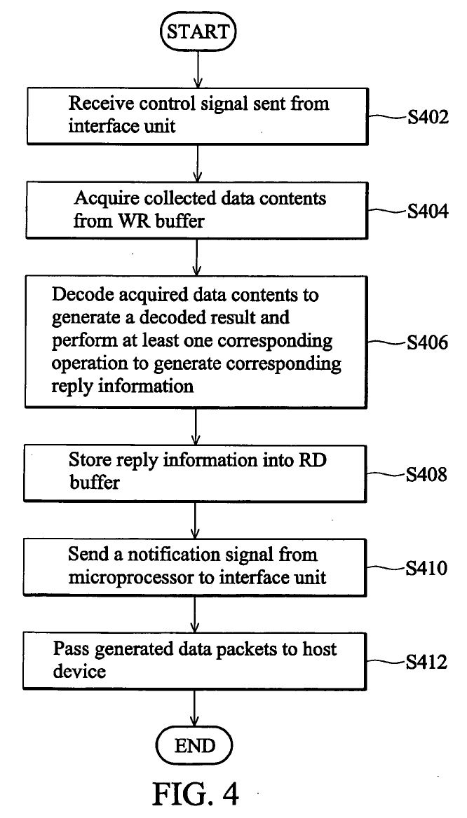

FIG. 4 is a flowchart of a data transmission method for transmission from a display apparatus to a host device according to the invention. Upon receiving the control signal (step S402), collected data contents are acquired from the WR buffer 142 (step S404), decoded to generate a decoded result and performed at least one operation corresponding to the decoded result to generate a corresponding reply information by the microprocessor 120 (step S406). For example, if the decoded result indicating that the request sent by the host device 200 is a command relating to obtaining settings data of the display apparatus 100, the microprocessor 120 may decode the request to recognize the meaning of that command and perform a corresponding operation to obtain the required settings data so as to generate a corresponding reply information with the required settings data to the interface unit 130 to respond to the host device 200. Meanwhile, the microprocessor 120 may store a portion of the generated reply information during the decoding process or store all of the generated reply information after the decoding process is completed into the RD buffer 144 (step S410).

After the reply information is generated, a notification signal (e.g. an interrupt signal S2) is sent by the microprocessor 120 to inform the interface unit 130 that the reply information is ready (step S410). Upon receiving the notification signal, the reply information is acquired from the RD buffer 144, decoded and data packets with corresponding header data forming a predetermined data format (e.g. DDC/CI or I2C data packets) based on the decoded result by the protocol converter 132 of the interface unit 130 are generated. Finally, the generated data packets are passed to the host device 200 using a predefined communication protocol (e.g. I2C communication protocol) via the communication line 300 (step S412).

Compared with the conventional implementation for a DDC/CI communication, which implementation a DDC/CI communication by utilizing the microprocessor or an additional chip capable of receiving I2C data packets, data transfer between the microprocessor and the buffers is faster, so that any request that contains a plurality of data packets can be obtained by the microprocessor in a short period of time. Therefore, data transmission between the host device and the display apparatus of the invention is speedy.

It is to be noted that although only one communication line is utilized to connect to the host device in the above-mentioned embodiments, the invention may also be applied to any host device having more than one communication line connected to the display apparatus. In this case, referring to FIG. 2, a destination address may used to identify data transfer to be performed via which communication line. Thus, the interface unit provides a number of connection interfaces, which is the same as that of the communication lines, to be able to receive requests from the host device in which each connection interface may have a corresponding unique address. The protocol converter may acquire data contents including the destination address from the request and then the microprocessor may recognize which interface the data is coming from and send the reply information with a corresponding rely address. In other words, only the way the data content is collected is varied, however, the previously described method of the invention for data transmission between the host device and the display apparatus may be performed for transmission therebetween.

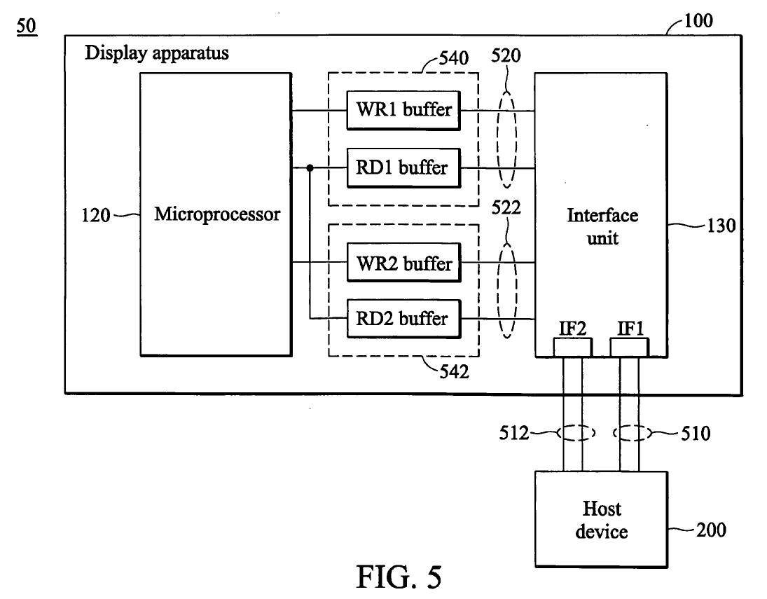

FIG. 5 shows another embodiment of a communication system 50. Referring to FIGS. 1 and 5, the communication system 50 is similar to the communication system 10 except that two communication lines 510 and 512 are used for connection between the display apparatus and the host device. Thus, two connection interfaces IF1 and IF2 along with two communication paths 520 and 522 between the buffering units 540 and 542 and the microprocessor are inside the display apparatus so as to process the data transmitted from/to the communication lines 510 and 520, respectively, for example, but not limited thereto. In this embodiment, each data path may be identified by using a unique address. For example, a data path from 510, 520 to the microprocessor using the buffering unit 540 may be identified by using a first address as the destination address while a data path from 512, 522 to microprocessor using the buffering unit 542 may be identified by using a second address as the destination address. Thus, as described previously, the data transmission methods shown in FIGS. 3 and 4 can be properly adjusted to be applied in the communication system 50 and details are omitted here for brevity.

According to the invention, with the protocol converter and buffering unit, every data packet forming a request will be received and buffered into an assigned buffer (e.g. FIFO) and appropriately decoded during a data transfer and thus saves processing time for the microprocessor to process the reception of all the data packets, providing better performance for a DDC/CI communication. Moreover, decoding or parsing of the DDC/CI commands is still performed by the microprocessor, allowing flexibility for implementation modifications if the related specifications is changed.

While the invention has been described by way of examples and in terms of preferred embodiments, it is to be understood that the invention is not limited thereto. Any variation or modification can be made by those skilled in art without departing from the spirit or scope of the invention. Therefore, the scope of the appended claims should be accorded the broadest interpretation to encompass all such modifications and similar arrangements.

What is claimed is:

1. A display apparatus coupled to a host device, comprising:
a control module, sequentially receiving data packets from the host device, acquiring data content from each of the received data packets, collecting each of the data contents, and, when data transfer has been completed, sending a control signal; and
a microprocessor coupled to the control module, in response to the control signal, acquiring the collected data contents from the control module, decoding the acquired data contents to generate a decoded result and performing at least one operation corresponding to the decoded result to generate a reply information to the host device.

2. The display apparatus as claimed in claim 1, wherein the control module further comprises:
an interface unit coupled to the host device, sequentially receiving the data packets from the host device, acquiring the data content from each of the received data packets, and, when data transfer has been completed, sending a control signal; and
a buffering unit coupled to the interface unit, collecting each of the data contents acquired by the interface unit.

3. The display apparatus as claimed in claim 2, wherein the interface unit further comprises:
at least one connection interface connected to the host device, receiving the data packets; and
a converting unit, acquiring the data content from each of the received data packets, and, when data transfer has been completed, sending a control signal.

4. The display apparatus as claimed in claim 2, wherein the buffering unit further comprises first and second buffers for storing data contents acquired by the interface unit and the reply information generated by the microprocessor, respectively.

5. The display apparatus as claimed in claim 4, wherein the microprocessor further generates a notification signal to notify the interface unit to read the reply information from the second buffer.

6. The display apparatus as claimed in claim 4, wherein the control signal and the notification signal buffer is an interrupt signal.

7. The display apparatus as claimed in claim 1, wherein the received data packet is of a data format compatible with DDC/CI standard.

8. The display apparatus as claimed in claim 1, wherein the control module further generates corresponding I2C data packets according to the reply information, and sends the corresponding I2C data packets to the host device.

9. A data transmission method for transmission between a host device and a display apparatus, wherein the display apparatus comprises a microprocessor and a control module, comprising:
sequentially receiving data packets from the host device by the control module;
acquiring data content from each of the received data packets;
collecting each of the data contents;
when data transfer has been completed, sending a control signal;
acquiring the collected data contents from the control module by the microprocessor in response to the control signal;
decoding the acquired data contents to generate a decoded result; and
performing at least one operation corresponding to the decoded result to generate a reply information to respond to the host device.

10. The data transmission method as claimed in claim 9, further comprising:
providing an interface unit for sequentially receiving the data packets from the host device, acquiring the data content from each of the received data packets, and, when data transfer has been completed, sending the control signal; and
providing a buffering unit for collecting each of the data contents.

11. The data transmission method as claimed in claim 10, wherein the interface unit further comprises a converting unit and at least one connection interface, and the method further comprises:
utilizing the connection interface for receiving the data packets; and
utilizing the converting unit for acquiring the data content from each of the received data packets, and, when data transfer has been completed, sending a control signal.

12. The data transmission method as claimed in claim 10, wherein the buffering unit further comprises first and second buffers, and the method further comprises:
storing data contents acquired by the interface unit and the reply information generated by the microprocessor into the first and second buffers, respectively.

13. The data transmission method as claimed in claim 12, wherein the microprocessor further generates a notification signal to notify the interface unit to read the reply information from the second buffer.

14. The data transmission method as claimed in claim 12, wherein the control signal and the notification signal buffer is an interrupt signal.

15. The data transmission method as claimed in claim 9, wherein the received data packet is of a data format compatible with DDC/CI standard.

16. The data transmission method as claimed in claim 9, wherein the control module further generates corresponding I2C data packets according to the reply information, and sends the corresponding I2C data packets to the host device.

17. A communication system, comprising:
a host device, sending a request with a plurality of data packets; and
a display apparatus coupled to the host device, comprising:
a control module, sequentially receiving data packets from the host device, acquiring data content from each of the received data packets, collecting each of the data contents, and, when data transfer has been completed, sending a control signal; and
a microprocessor coupled to the control module, in response to the control signal, acquiring the collected data contents from the control module, decoding the acquired data contents to generate a decoded result and performing at least one operation corresponding to the decoded result to generate a reply information to the host device.

18. The communication system as claimed in claim 17, wherein the control module further comprises a buffering unit for temporarily collecting each of the acquired data contents during the data transfer.

19. A data transmission method for performing a Display data channel/command interface (DDC/CI) transmission between a host device and a display apparatus, wherein the display apparatus comprises a microprocessor and a control module, comprising:
receiving all of data packets corresponding to a request from the host device by the control module; and
informing the microprocessor to acquire the received data packets when data transfer has been completed; and
decoding the acquired data packets to generate a decoded result by the microprocessor,
wherein each of the acquired data packets is stored together during the data transfer.

20. The data transmission method as claimed in claim 19, further comprising:
generating a corresponding reply information to respond to the host device according to the decoded result by the microprocessor;
informing the control module to acquire the reply information; and
passing the reply information to the host device by the control module,
wherein the reply information is stored into a buffering unit of the control module.
